(19) United States
(12) Patent Application Publication
(10) Pub. No.: US 2006/0209004 A1
(43) Pub. Date: Sep. 21, 2006

(54) LCD device having a homogeneous LC layer

(75) Inventors: Hiroshi Nagai, Nakahara-ku (JP); Hidenori Ikeno, Nakahara-ku (JP)

Correspondence Address: HAYES, SOLOWAY P.C., 3450 E. SUNRISE DRIVE, SUITE 140, TUCSON, AZ, 85718, US

(73) Assignee: NEC LCD Technologies, Ltd.

(21) Appl. No.: 11/297,272

(22) Filed: Dec. 8, 2005

(30) Foreign Application Priority Data
Dec. 8, 2004 (JP) 2004-355438

(51) Int. Cl. G09G 3/36

(52) U.S. Cl. 345/102

(57) ABSTRACT

An LCD device includes an LC panel, and a backlight unit having a backlight source and a luminous intensity control unit. The backlight source has a peak luminous intensity in each of wavelength ranges corresponding to red, green and blue colors. The luminous intensity control unit controls the peak luminous intensity of the wavelength range corresponding to the blue color at a lower gray scale level of the LCD unit to be lower than that at a higher gray scale level, to thereby prevent the chromaticity on the screen from shifting toward blue color.

### BACKGROUND OF THE INVENTION

(a) Field of the Invention

The present invention relates to a liquid crystal display (LCD) device having a homogeneously aligned LC layer.

(b) Description of the Related Art

In general, LCD devices include a liquid crystal (LC) panel wherein an LC layer including therein LC molecules is sandwiched between a pair of substrates, and a pair of polarizing films sandwiching therebetween the LC panel. The LCD device represents an image on the screen thereof by controlling the tilt angle of the longer axis of the LC molecules. An in-plane-switching-mode (IPS-mode) LCD device, for example, includes a homogeneously aligned LC layer and a pair of polarizing films disposed so that the polarizing axes thereof are perpendicular to each other. An electric field parallel to the substrate surface is applied to the LC layer, to rotate the LC molecules parallel to the substrate surface for the display of image.

It is known in the LCD device that the gray scale level represented on the screen of the LCD device involves change of color from the original color. FIG. 8 shows the change of color, or chromaticity shift, on the screen upon changing the gray scale level. In this example, the luminance of each color is represented using 256 gray scale levels. If the color on the screen is changed from black color to white color, i.e., from (R,G,B)=(0,0,0) to (R,G,B)=(255,255,255), the chromaticity observed by human eyes shifts on the X-Y chromaticity coordinate along the line connecting the square dots in FIG. 8. In FIG. 8, a black-body radiation locus is also depicted by curve (a) for reference. As understood from FIG. 8, a lower gray scale level causes the observed chromaticity to shift toward blue color. This is considered attributable to the fact that the transmission factor of the polarizing films having polarization axes disposed perpendicular to each other is higher in the lower wavelength range than in the higher wavelength range. This chromaticity shift along with the change of the gray scale level reduces the reproducibility of chromaticity, thereby incurring degradation in the image quality of the LCD device.

A technique for suppressing the chromaticity shift accompanying the change of gray scale level is described in a first literature entitled “LC Technique wherein a luminance change does not change chromaticity, “Authentic Color IPS””, Electronic Material June, 2002, Separate Volume, by Y. Utsumi. In this technique, a lookup table is used to reduce the transmission level of blue color (B) among three primary colors, RGB, depending on the luminance to thereby suppress the chromaticity shift toward the blue color; for example, (128, 128, 128) representing the original color is changed to (128, 128, 92) for suppression of the blue color.

Another technique for suppressing the chromaticity shift is described in a second literature entitled “Color reproducibility characteristic and reproduction of the standard color in an LCD panel” in Sharp technical report, Vol. 80, August 2001, p43-46. In this technique, the retardation of LC layer is reduced to reduce the peak-wavelength shift off the light passed by the LC layer, thereby reducing the chromaticity shift.

### DISCLOSURE OF THE INVENTION

(a) Problems to be Solved by the Invention

It is noted in the present invention that reduction of the transmission level for the blue color accompanying the change of gray scale level, as proposed in the first literature, does not well reduce the amount of chromaticity shift toward the blue color. It is also noted that the reduction of retardation of the LC layer, as employed in the second literature, necessitates reduction of the thickness of the LC layer, which is accompanied by a variety of technical problems.

In view of the above problems in the conventional techniques, it is an object of the present invention to provide an LCD device which is capable of suppressing the chromaticity shift between a higher gray scale level and a lower gray scale level.

(b) Means for Solving the Problems

The present invention provides, in a first aspect thereof, a liquid crystal display (LCD) device including a pair of transparent substrates, a homogeneously aligned liquid crystal (LC) layer sandwiched therebetween and including therein LC molecules having longer axes aligned in parallel to a surface of the transparent substrates, and a backlight unit supplying backlight to the LC layer, wherein: the backlight unit comprises a backlight source having a peak luminous intensity in each of first through third wavelength ranges of 380 to 490 nm, 490 to 590 nm and 590 to 800 nm, respectively, and a luminous intensity control unit for controlling a luminous intensity of the backlight source to control a gray scale level of the LCD device; and the luminous intensity control unit controls the peak luminous intensity of the first wavelength range at a first gray scale level to be lower than the peak luminous intensity of the first wavelength range at a second gray scale level which is higher than the first gray scale level.

The present invention provides, in a second aspect thereof, liquid crystal display (LCD) device including a pair of transparent substrates, a homogeneously aligned liquid crystal (LC) layer sandwiched therebetween and including therein LC molecules having longer axes aligned in parallel to a surface of the transparent substrates, and a backlight unit supplying backlight to the LC layer, wherein: the backlight unit comprises a backlight source having a peak luminous intensity in each of first through third wavelength ranges of 380 to 490 nm, 490 to 590 nm and 590 to 800 nm, respectively, and a luminous intensity control unit for controlling a luminous intensity of the backlight source to control a gray scale level of the LCD device in each of a plurality of divided screen areas of the LCD device; and the luminous intensity control unit controls the peak luminous intensity of the first wavelength range, in a first screen area representing a first gray scale level, to be lower than the peak luminous intensity of the first wavelength range in a second screen area representing a second gray scale level which is higher than the first gray scale level.

In accordance with the LCD device of the present invention, the specific peak luminous intensity of the first wavelength range, which is lower at the first gray scale level than at the second gray scale level, prevents the chromaticity shift of the backlight toward the blue color, thereby reducing the chromaticity difference between the colors observed at different gray scale levels, or between the colors observed in the different divided areas of the screen, to improve the image quality of the LCD device.

The above and other objects, features and advantages of the present invention will be more apparent from the following description, referring to the accompanying drawings.

### BRIEF DESCRIPTION OF THE DRAWINGS

FIG. 1 is a sectional view of an LCD device according to an embodiment of the present invention.

FIG. 2 is a graph showing the luminance spectrum diagrams of the backlight unit.

FIG. 3 is a graph showing the chromaticity shift upon changing the luminous intensity of blue color in the backlight.

FIG. 4 is a graph showing the relationship obtained by a simulation between, the luminous intensity of blue color and chromaticity shift at a 6 level and a 20 level in terms of intensity among the gray scale level of the LCD device.

FIG. 5 is a graph showing the chromaticity shit obtained by a simulation from a zero level to a 99 level in the gray scale level of the LCD device.

FIG. 6 is a graph showing the relationship obtained by a simulation between the luminous intensity of blue color and the contrast ratio of the LCD device.

FIG. 7 is a perspective view of the LC panel having a screen divided into four sub-areas.

FIG. 8 is a graph showing the chromaticity shift upon changing the gray scale level of the LC panel.

FIG. 9 is a graph showing the transmission-wavelength characteristic of a pair of polarization films disposed so that the polarization axes are perpendicular to each other.

### PREFERRED EMBODIMENT OF THE INVENTION

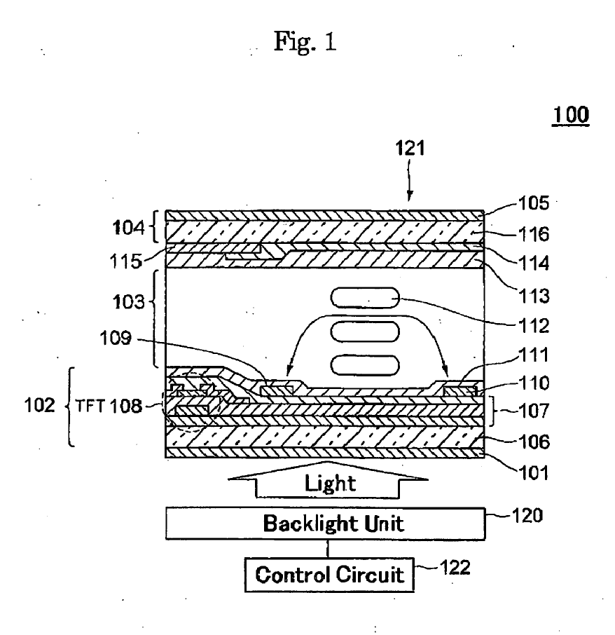

Now, the present invention is more specifically described with reference to accompanying drawings. FIG. 1 shows an LCD device according to an embodiment of the present invention. The LCD device, generally designated by numeral 100 includes backlight unit 120, LC panel 121, and control circuit 122. The LC panel 121 includes light-incident-side polarizing film 101, transistor-array (TFT) substrate 102, orientation film 111, LC layer 103, orientation film 113, color-filter (CF) substrate 104, and light-emitting-side polarizing film 105, which are arranged in this order along the direction of light transmission.

The LC layer 103 includes therein homogeneously aligned LC molecules 112. The polarizing films 101, 105 each have a function of passing therethrough light having a polarization aligned with the polarization axis thereof. The polarizing films 101, 105 are disposed so that the transmission axes thereof are perpendicular to each other. The TFT substrate 102 includes glass substrate body 106, insulating film 107, TFTs 108, pixel electrodes 109 and counter electrode 110. The TPTs 108 control the voltage applied to the pixel electrodes 109. The CF substrate 104 includes coloring layer 114, light shield film 115 and glass substrate body 116. The coloring layer 114 colors the light passed by the LC layer 103 to assume one of three primary colors, RGB. The light shield film 115 shields the TFTs 108, data lines (not shown) etc. against the light. In the LCD device 100, the voltage applied between the pixel electrodes 109 and counter electrode 110 impresses a lateral electric field to the LC molecules in the LC layer 103 for display of color image.

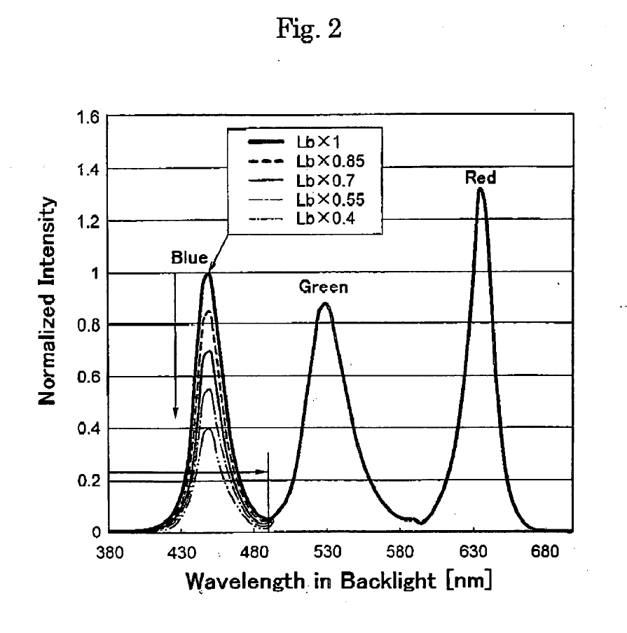

The backlight unit 120 generates backlight to be incident onto the LC panel 121. The backlight unit 120 is of a direct emission type, and includes therein LEDs each corresponding to one of RGB primary colors behind a diffusion plate. FIG. 2 shows luminance spectra versus wavelength of the backlight, wherein the luminous intensity of the blue color in the backlight unit is shown as controlled from the peak value (Lb) to a lower luminous intensity of 0.4×Lb. As shown in the drawing, the backlight unit 120 has a peak of the luminous intensity in each of the wavelength ranges corresponding to red color (591 to 800 nm), green color (491 to 590 nm) and blue color (380 to 490 nm). The backlight unit 120 is controlled by a control circuit 122 for the luminous intensity thereof at least in the peak of the blue color.

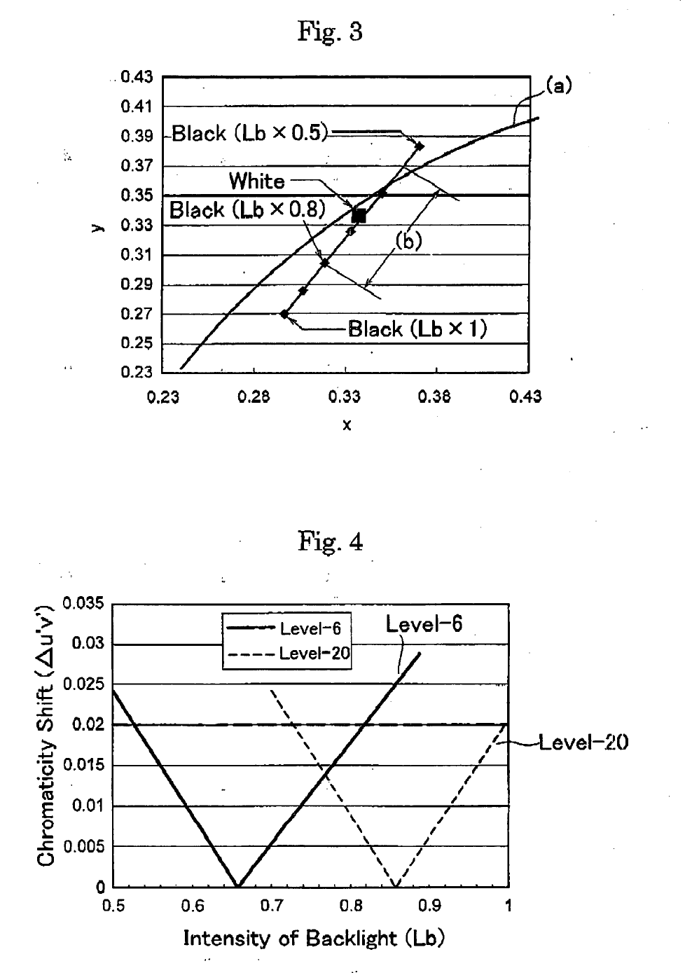

FIG. 3 shows the chromaticity shift upon change of the luminous intensity in the blue, color of the backlight. In this figure, curve (a) represents the black-body radiation locus. The present inventors conducted a simulation for measuring the chromaticity upon display of black color for a variety of luminous intensities of the backlight, by stepwise changing only the luminous intensity of the blue color in the backlight, with, the luminous intensity of red and green colors being fixed, as shown in FIG. 2. In this simulation, the gray scale from white color to black color is divided into 100 gray scale levels, assuming that the gray scale levels of black color and white color are a zero level and a 99 level, respectively, in terms of intensity. In FIGS. 2 and 3, the symbol Lb represents the luminous intensity of black color upon display of white color, i.e., gray scale level of 99. The luminous intensity of blue color upon the display of black color was changed from Lb to 0.3×Lb in a stepwise fashion. During the change of luminous intensity of the blue color in the backlight unit 120 from the level of 99 to the lower level, the chromaticity was changed as shown in FIG. 3 depending on the luminous intensity of blue color. The range denoted by (b) shows the area wherein chromaticity shift is scarcely observed by human eyes.

FIG. 4 shows the results obtained by the simulation for the relationship between the luminous intensity of blue color and chromaticity difference for the case of gray scale levels of 6 and 20. In FIG. 4, the luminous intensity of blue color of the backlight unit 120 is plotted on the abscissa in terms of the ratio with respect to the luminous intensity of the blue color at the level of 99. The chromaticity difference is obtained by determining the X-Y chromaticity at each of the luminous intensity of blue color while changing the luminous intensity of blue color of the backlight in the range between the gray scale level (0, 0, 0) and the gray scale level (25, 25, 25), converting the determined X-Y chromaticity into u′v′ chromaticity, and by using the following formula:
Δu′v′=\sqrt{(u′1−u′0)²+(v′1−V′0)²}
where the chromaticity (u′, V′) at the level of 99 is represented by (u′, v′)=(u′0, v′0). The relationship between the luminous intensity of blue color and chromaticity difference Δu′v′ at gray scale levels of 6 and 20 is shown in FIG. 4, as representative graphs.

In general, an observer of the LCD device scarcely perceives the chromaticity shift if the chromaticity difference is within 0.02, as recited in a literature “NIKKEI MICRODEVICES May 2004”, p34. Thus, the range of the luminous intensity of blue color which achieved the chromaticity difference of 0.02 or below at each gray scale level was determined by a simulation. The range of luminous intensity (L.I.) of blue color obtained by the simulation is as follows:
0.5×Lb≦L.I.≦0.85×Lb,
for a range of gray scale levels of the LCD device between 0and 15; and
0.7×Lb≦L.I.≦1×Lb,
for a range of gray scale levels of the LCD device between 16 and 25.

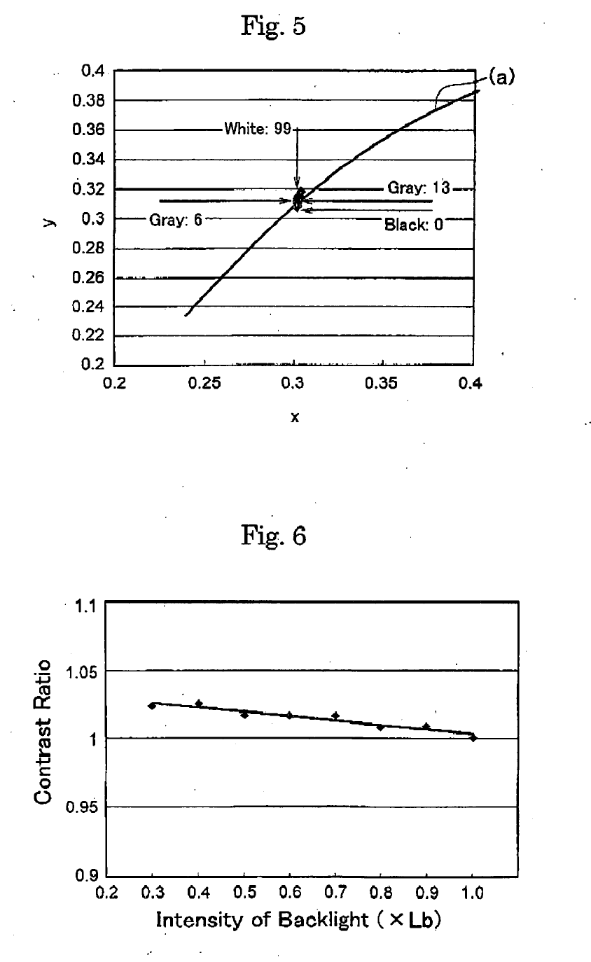

FIG. 5 shows results of another simulation, representing the chromaticity shift on the X-Y chromaticity coordinate for the case of changing the gray scale level from 0 to 99. In this simulation, the luminous intensity of blue color in the backlight is set at 0.65×Lb for the gray scale levels between 0 and 15, set at 0.85×Lb for the gray scale levels between 16 and 25, and set at 1.0×Lb for the gray scale levels between 26 and 99. As understood from FIG. 5, in this case, the chromaticity shift scarcely appears from the lower gray scale level to the higher gray scale level.

As described before, there was the problem in the conventional LCD device that the chromaticity shifts toward blue color upon display of a lower gray scale level. In the present embodiment, the luminous intensity of blue color is changed in the backlight unit depending on the gray scale level to be displayed on the screen of the LC device so that the luminous intensity of blue color is lower at a lower gray scale level than at a higher gray scale level. By controlling the luminous intensity of blue color in the backlight unit 120, the chromaticity shift toward the blue color is prevented, whereby a LCD device is obtained having a lower chromaticity shift between the lower gray scale level and the higher gray scale level of the LCD device.

FIG. 6 shows the relationship obtained by a simulation between the luminous intensity of blue color and the contrast ratio of the LCD device. In this figure, each contrast ratio is normalized by the contrast ratio when the luminous intensity of blue color upon display of black color is equal to the luminous intensity of the blue color upon display of white color. If the luminous intensity of blue color in the backlight upon display of black color is lower than that upon display of whit,e color, the overall luminous intensity of the backlight unit 120 is lower than the overall luminous intensity of the backlight unit 120 upon display of white color. Thus, the intensity of leakage light upon display of black color is lower than the intensity of leakage light when the luminous intensity of blue color is not reduced. Accordingly, the contrast ratio is reduced along with the reduction of the luminous intensity of blue color, as shown in FIG. 6. In the present embodiment, the lower luminous intensity of blue color upon display of black color compared to the luminous intensity of blue color upon display of white color provides a higher contrast ratio compared to the case where the luminous intensity of blue color is not reduced.

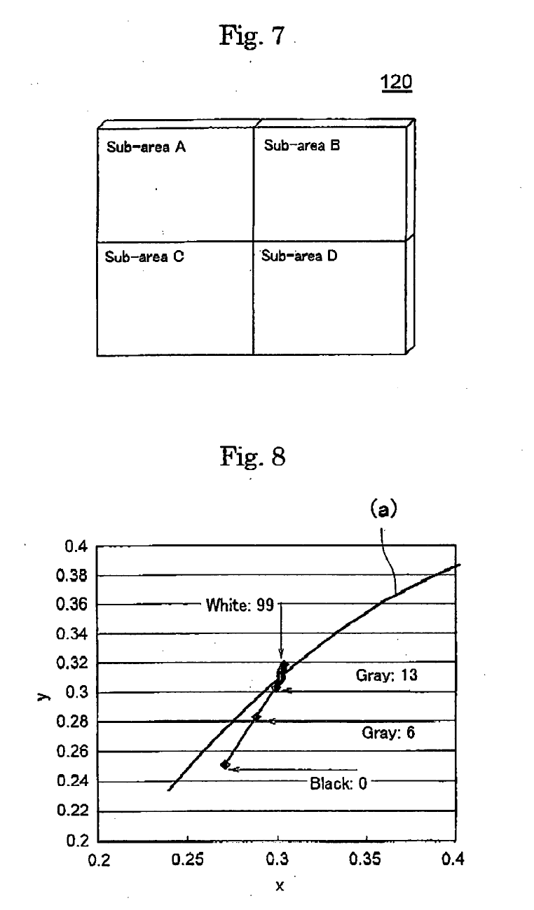

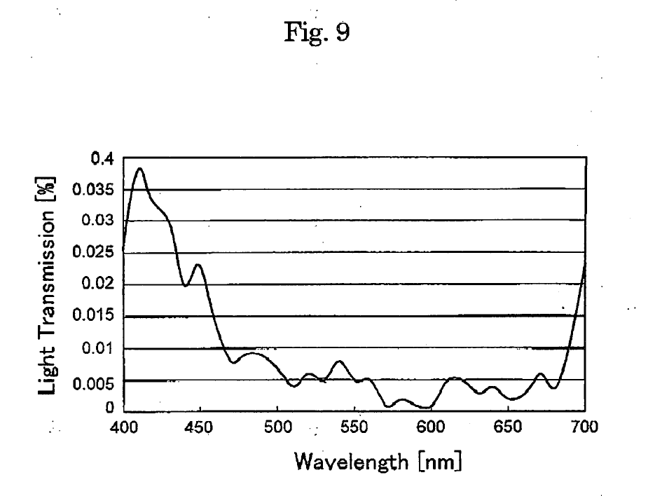

FIG. 7 shows area division of the backlight unit in an LCD device according to a second embodiment of the present invention. In the present embodiment, the screen surface of the LCD device is divided into a plurality of sub-areas, and the area of the backlight 120 is also divided into a plurality of sub-areas corresponding to the sub-areas of the screen surface. In each of the sub-areas of the backlight unit 120, the luminous intensity of blue color is controlled independently of other sub-areas. More specifically, the luminous intensity of blue color is controlled in each of the sub-areas of the backlight unit 120 based on the gray scale level of the sub-area of the screen surface.

In FIG. 7, if the screen sub-area corresponding to the sub-area A of the backlight unit has a gray scale level of 0 to 15, the luminous intensity of blue color in the sub-area A is controlled in the range between 0.5×Lb and 0.85×Lb. If the screen sub-area corresponding to the sub-area B has a gray scale level of 16 to 25, the luminous intensity of blue color in the sub-area B is controlled in the range between 0.7×Lb and 1×Lb. By dividing the screen surface into a plurality of sub-areas and controlling the blue color component of the backlight in the sub-area based on the gray scale level of the sub-area, the image quality of the LCD device can be improved compared to simply controlling the blue color component of the backlight based on the gray scale level of the screen surface as a whole.

In the above embodiments, LEDs corresponding to three primary colors are exemplarily used as the backlight unit. However, the backlight unit is not limited to the LEDs so long as the luminous intensity of blue color is controllable. For example, the LEDs may be replaced by a three-color tube. The backlight unit is also not limited to the direct emission type, and may be an indirect emission type having a light conductive plate. The RGB colors need not be emitted concurrently, and may be emitted in a time division scheme such as feed-sequential scheme. Although the present embodiment is described with reference to the IPS-mode LCD device, the present invention can be applied to another-mode LCD device wherein the chromaticity shift occurs in the lower gray scale-range, for example.

In the above embodiment, the backlight unit 120 is controlled only for the luminous intensity of blue color, with the luminous intensity of red and green colors being fixed. In an alternative, the luminous intensity of the light as a whole may be controlled depending on the gray scale level, with the ratio among the luminous intensities of the red, green and blue colors being fixed.

For example, assuming that Lwr, Lwg and Lwb represent luminous intensities of red, green and blue colors, respectively, upon display of white color, the backlight unit 120 reduces the luminous intensity of each color while changing the ratio among the three primary colors between Lwr:Lwg:0.5×Lwb and Lwr:Lwg:0.85×Lwb for a gray scale level between 0 and 15. The backlight unit also reduces the luminous intensity of the light as whole while changing the ratio between Lwr:Lwg:0.7×Lwb and Lwr:Lwg:Lwb for a gray scale level between 16 and 25.

The configuration, wherein the backlight unit reduces the overall luminous intensity of the light incident onto the LC panel upon display at lower gray scale levels and increases the overall luminous intensity of the light incident onto the LC panel, provides a further improvement in the contrast ratio of the LCD device.

Since the above embodiments are described only for examples, the present invention is not limited to the above embodiments and various modifications or alterations can be easily made therefrom by those skilled in the art without departing from the scope of the present invention.

What is claimed is:

1. A liquid crystal display (LCD) device comprising a pair of transparent substrates, a homogeneously aligned liquid crystal (LC) layer sandwiched therebetween and including therein LC molecules having longer axes aligned in parallel to a surface of said transparent substrates, and a backlight unit,supplying backlight to said LC layer, wherein;
said backlight unit comprises a backlight source having a peak luminous intensity in each of first through third wavelength ranges of 380 to 490 nm, 490 to 590 nm and 590 to 800 nm, respectively, and a luminous intensity control unit for controlling a luminous intensity of said backlight source to control a gray scale level of said LCD device; and
said luminous intensity control unit controls said peak luminous intensity of said first wavelength range at a first gray scale level to be lower than said peak luminous intensity of said first wavelength range at a second gray scale level which is higher than said first gray scale level.

2. The LCD device according to claim 1, wherein said second gray scale level is the highest gray scale level of said LCD device.

3. The LCD device according to claim 1, wherein said first gray scale level is the lowest gray scale level of said LCD device.

4. The LCD device according to claim 1, wherein, assuming that Lwb is the peak luminous intensity of said first wavelength range upon display of white color in said LCD device, and that said gray scale level is divided into 100 levels, with black color being a zero level and white color being a 99 level in terms of intensity,
said luminous intensity control unit controls said backlight source so that said luminous intensity of said first wavelength range assumes 0.5×Lwb to 0.85×Lwb at a gray scale level between a zero level and a 15 level, and 0.7×Lwb to 1.0×Lwb at a gray scale level between a 16 level and a 25 level.

5. The LCD device according to claim 1, wherein, assuming that said peak luminous intensities of said first through third wavelength ranges are Lwb, Lwg and Lwr, respectively, upon display of white color in said LCD device, and that said gray scale level of said LCD device is divided into 100 levels, with black color being a zero level and white color being a 99 level in terms of intensity,
said luminous intensity control unit controls said backlight source so that a ratio among said peak luminous intensities of said first through third wavelength ranges assumes 0.5×Lwb to 0.85×Lwb:Lwg:Lwr at a gray scale level between a zero level and a 15 level, and assumes 0.7×Lwb to 1.0×Lwb:Lwg:Lwr at a gray scale level between a 16 level and a 25 level.

6. The LCD device according to claim 1, wherein said luminous intensity control unit controls an overall luminous intensity of said first wavelength range at said first gray scale level to be lower than an overall luminous intensity of said first wavelength range at said second gray scale level.

7. A liquid crystal display (LCD) device comprising a pair of transparent substrates, a homogeneously aligned liquid crystal (LC) layer sandwiched therebetween and including therein LC molecules having longer axes aligned in parallel to a surface of said transparent substrates, and a backlight unit supplying backlight to said LC layer, wherein:
said backlight unit comprises a backlight source having a peak luminous intensity in each of first through third wavelength ranges of 380 to 490 nm, 490 to 590 nm and 590 to 800 nm, respectively, and a luminous intensity control unit for controlling a luminous intensity of said backlight source to control a gray scale level of said LCD device in each of a plurality of divided screen areas of said LCD device; and
said luminous intensity control unit controls said peak luminous intensity of said first wavelength range, in a first screen area representing a first gray scale level, to be lower than said peak luminous intensity of said first wavelength range in a second screen area representing a second gray scale level which is higher than said first gray scale level.

8. The LCD device according to claim 7, wherein said second gray scale level is the highest gray scale level of said LCD device.

9. The LCD device according to claim 7, wherein said first gray scale level is the lowest gray scale level of said LCD device.

10. The LCD device according to claim 7, wherein, assuming that Lwb is the peak luminous intensity of said first wavelength range upon display of white color in said LCD device, and that said gray scale level of said LCD device is divided into 100 levels, with black color being a zero level and white color being a 99 level in terms of intensity,
said luminous intensity control unit controls said backlight source so that said luminous intensity of said first wavelength range in each of said divided screen area assumes 0.5×Lwb to 0.85×Lwb at a gray scale level between a zero level and a 15 level, and assumes 0.7×Lwb to 1.0×Lwb at a gray scale level between a 16 level and a 25 level.

11. The LCD device according to claim 7, wherein, assuming that said peak luminous intensities of said first through third wavelength ranges are Lwb, Lwg and Lwr, respectively, upon display of white color in said LCD device, and that said gray scale level of said LCD device is divided into 100 levels, with black color being a zero level and white color being a 99 level,
said luminous intensity control unit controls said backlight source so that a ratio among peak luminous intensities of said first through third wavelength ranges in each of said divided screen areas assumes 0.5×Lwb to 0.85×Lwb:Lwg:Lwr at a gray scale level between a zerolevel and a 15 level, and assumes 0.7×Lwb to 1.0×Lwb:Lwg:Lwr at a gray scale level between a 16 level and a 25 level.

12. The LCD device according to claim 7, wherein said luminous intensity control unit controls, in each of divided screen areas, an overall luminous intensity of said first wavelength range at said first gray scale level to be lower than an overall luminous intensity of said first wavelength range at said second gray scale level.
